(19) United States
(12) Patent Application Publication
(10) Pub. No.: US 2025/0208283 A1
(43) Pub. Date: Jun. 26, 2025

(54) ENHANCED RADAR OBJECT DETECTION VIA DYNAMIC AND STATIC DOPPLER SPECTRUM PARTITIONING

(71) Applicant: GM GLOBAL TECHNOLOGY OPERATIONS LLC, Detroit, MI (US)

(72) Inventors: Yuval HAITMAN, Ramat-Gan (IL); Oded BIALER, Petach Tikva (IL)

(21) Appl. No.: 18/394,943

(22) Filed: Dec. 22, 2023

(51) Int. Cl. G01S 13/53; G01S 7/292; G01S 7/41; G01S 13/526; G01S 13/58; G01S 13/931

(52) U.S. Cl. CPC G01S 13/53; G01S 7/292; G01S 7/417; G01S 13/588; G01S 13/589; G01S 13/526; G01S 2013/932

(57) ABSTRACT

A system for enhancing object detection includes at least one radar device configured to detect signals reflected by objects and a control module. The control module is configured to generate a radar spectrum based on the signals detected by the at least one radar device, partition the radar spectrum into static reflections and dynamic reflections separate from the static reflections, extract features from the static reflections with a first machine learning module, extract features from the dynamic reflections with a second machine learning module different than the first machine learning module, merge the extracted features from the static reflections and the extracted features from the dynamic reflections, and detect static objects and dynamic objects based on the merged features from the static reflections and the dynamic reflections. Other example systems and methods for enhancing object detection are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to enhanced radar object detection via dynamic and static doppler spectrum partitioning.

A vehicle may include a driver assistance system that relies on sensors for blind spot detection, adaptive cruise control, lane departure warnings, etc. In some cases, the sensors may include a radar device (e.g., a long-range or a short-range radar device) to detect objects in the vicinity of the vehicle. Specifically, the radar device detects the objects by emitting waves (e.g., electromagnetic waves, radio waves, etc.) and then detecting reflected waves from the objects.

### SUMMARY

A vehicle system for enhancing object detection in a vehicle includes at least one radar device configured to detect signals reflected by objects in a vicinity of the vehicle, and a control module in communication with the at least one radar device. The control module is configured to generate a radar spectrum based on the signals detected by the at least one radar device, partition the radar spectrum into static reflections and dynamic reflections separate from the static reflections, extract features from the static reflections with a first machine learning module, extract features from the dynamic reflections with a second machine learning module different than the first machine learning module, merge the extracted features from the static reflections and the extracted features from the dynamic reflections, and detect static objects and dynamic objects in the vicinity of the vehicle based on the merged features from the static reflections and the dynamic reflections.

In other features, the first machine learning module and the second machine learning module are separate deep neural networks.

In other features, the control module is configured to determine Doppler bins for the static reflections based on a velocity of the vehicle.

In other features, the control module is configured to separate the determined Doppler bins for the static reflections from the radar spectrum to partition the radar spectrum into static reflections and dynamic reflections.

In other features, the radar spectrum is a radar tensor formed of range values, angle values, and Doppler values, and each Doppler bin associates one of the range values and one of the angle values at the velocity of the vehicle.

In other features, the control module is configured to estimate the velocity of the vehicle based on data from the radar tensor.

In other features, the vehicle system further includes a sensor configured to detect the velocity of the vehicle.

In other features, the control module is configured to receive one or more signals from the sensor indicative of the velocity of the vehicle.

In other features, the control module is configured to generate a static feature map based on the extracted features from the static reflections, and generate a dynamic feature map based on the extracted features from the dynamic reflections.

In other features, the static feature map includes static feature vectors. Each static feature vector is associated with a learnable feature identified by the first machine learning module.

In other features, the dynamic feature map includes dynamic feature vectors. Each dynamic feature vector is associated with a learnable feature identified by the second machine learning module.

In other features, the control module is configured to concatenate the static feature map and the dynamic feature map to merge the extracted features from the static reflections and the extracted features from the dynamic reflections.

In other features, the vehicle system further includes a vehicle control module in communication with the control module. The vehicle control module configured to receive one or more signals from the control module indicative of the detected static objects and dynamic objects.

In other features, the vehicle control module is configured to control at least one vehicle control system based on the one or more signals.

In other features, the vehicle control module is configured to generate a map including the detected static objects and dynamic objects in the vicinity of the vehicle based on the one or more signals.

In other features, a vehicle includes the vehicle system.

A method system for enhancing object detection includes generating a radar spectrum based on signals detected by at least one radar device, partitioning the radar spectrum into static reflections and dynamic reflections separate from the static reflections, extracting features from the static reflections with a first machine learning module, extracting features from the dynamic reflections with a second machine learning module different than the first machine learning module, merging the extracted features from the static reflections and the extracted features from the dynamic reflections, and detecting static objects and dynamic objects based on the merged features from the static reflections and the dynamic reflections.

In other features, partitioning the radar spectrum includes determining Doppler bins for the static reflections.

In other features, partitioning the radar spectrum includes separating the determined Doppler bins for the static reflections from the radar spectrum.

In other features, the method further includes generating a static feature map based on the extracted features from the static reflections, and generating a dynamic feature map based on the extracted features from the dynamic reflections.

In other features, the static feature map includes static feature vectors. Each static feature vector is associated with a learnable feature identified by the first machine learning module.

In other features, the dynamic feature map includes dynamic feature vectors. Each dynamic feature vector is associated with a learnable feature identified by the second machine learning module.

In other features, merging the extracted features from the static reflections and the extracted features from the dynamic reflections includes concatenating the static feature map and the dynamic feature map.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system for enhancing object detection, according to the present disclosure;

FIG. 2 is a vehicle including portions of the vehicle system of FIG. 1, according to the present disclosure;

FIG. 3 is a functional block diagram of an example control process for enhancing object detection, according to the present disclosure;

FIG. 4 is a flowchart of an example control process for enhancing object detection, according to the present disclosure; and

FIG. 5 is a graph showing object detection improvements for a system employing object detection enhancement features over a conventional system.

In the drawings, reference numbers may be reused to identify similar and/or identical elements.

### DETAILED DESCRIPTION

A radar device emits waves and then detects reflected waves from both static and dynamic objects. The radar device or a control module associated with the device then processes data from the reflected waves to obtain a radar spectrum for the objects. The radar spectrum may include data in the form of a three-dimensional radar tensor with two dimensions having range values and angle values (e.g., range-azimuth space) and the third dimension having Doppler values with velocity information (e.g., velocity of the objects relative to the radar device). In such examples, the radar tensor combines data for both static and dynamic objects. However, detecting objects by processing a radar tensor with both types often results in limited performance. For instance, interference between static and dynamic objects may be induced due to a wide spreading function of the radar device, and different processing approaches (e.g., filtering) may be necessary due to the distinct shapes and Doppler spreads of the static and dynamic objects.

The systems and methods according to the present disclosure provide technical solutions for enhancing radar object detection by partitioning or dividing a radar spectrum into distinct static and dynamic components, independently extracting features from each component with differently trained machine learning modules (e.g., deep neural networks, etc.), and then merging the extracted features from the static and dynamic components. In doing so, static and dynamic objects may be more accurately detected as compared to conventional radar systems. For example, the systems and methods herein enhance the accuracy of object bounding boxes and velocity estimations in radar applications, thereby delivering improved results as compared to conventional radar systems that process the entire radar tensor. As such, the systems and methods herein provide improved object detection at long distance and at adverse weather conditions with high angular resolution, which in turn increases the coverage and driving speed of autonomous driving.

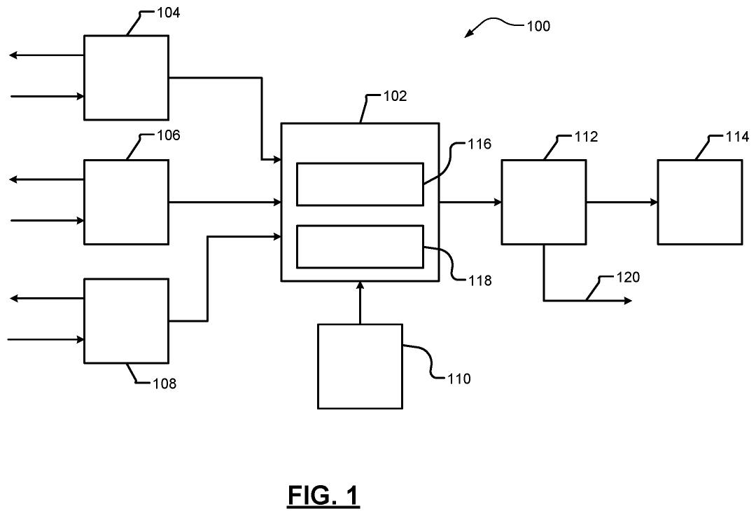

Referring now to FIG. 1, a block diagram of an example vehicle system 100 is presented for enhancing object detection. As shown in FIG. 1, the vehicle system 100 generally includes a control module 102 and multiple radar devices 104, 106, 108 in communication with the control module 102. Additionally, the vehicle system 100 may optionally include a velocity sensor 110 in communication with the control module 102, a vehicle control module 112 in communication with the control module 102, and a display module 114 in communication with the vehicle control module 112 (and/or the control module 102). Although FIG. 1 illustrates the vehicle system 100 as including multiple separate modules, it should be appreciated that any combination of the modules (e.g., the control module 102, the vehicle control module 112, the display module 114, etc.) and/or the functionality thereof may be integrated into one or more modules.

Although not shown in FIG. 1, the modules and sensors of the vehicle system 100 may share parameters via a network, such as a controller area network (CAN). In such examples, parameters may be shared via one or more data buses of the network. As such, various parameters may be made available by a given module and/or sensor to other modules and/or sensors via the network.

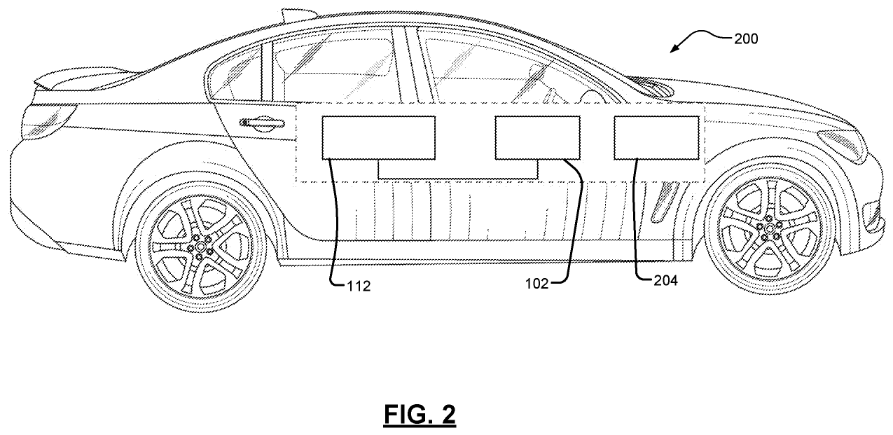

In various embodiments, the vehicle system 100 of FIG. 1 may be employable in any suitable vehicle, such as an electric vehicle (e.g., a pure electric vehicle, a plug-in hybrid electric vehicle, etc.), an internal combustion engine vehicle, etc. Additionally, the vehicle system 100 may be applicable to an autonomous vehicle, a semi-autonomous vehicle, etc. For example, FIG. 2 depicts a vehicle 200 including the control module 102 and the vehicle control module 112 of FIG. 1, and one or more radar devices 204 (e.g., one or more of the radar devices 104, 106, 108 of FIG. 1, etc.) in communication with the control module 102. In such examples, each radar device 204 detects reflected signals from both static and dynamic objects in the vicinity of the vehicle 200. In other examples, the systems disclosed herein may be implemented in other suitable non-vehicle applications including radar that detect reflected signals from static and dynamic objects.

With continued reference to FIG. 1, each radar device 104, 106, 108 may be any suitable radar device, such as a long-range radar device, a short-range radar device, etc. While the vehicle system 100 of FIG. 1 is shown and described as having three radar devices 104, 106, 108, it should be appreciated that the vehicle system 100 and/or other example systems may include more or less radar devices (e.g., one radar device, four radar devices, six radar devices, etc.) if desired. Regardless of the number of radar devices employed, each radar device emits waves or signals and then detects reflected waves or signals from both static and dynamic objects, as is conventional. The radar devices 104, 106, 108 then may transmit radar data indicative of the reflected waves to the control module 102.

Then, in various embodiments, a radar spectrum is generated based on the signals detected by at least one of the radar devices 104, 106, 108. For example, the control module 102 may receive the radar data, process the data, and form the radar spectrum based on the radar data. In other examples, a control module associated with one or more of the radar devices 104, 106, 108 may process the radar data, form the radar spectrum based on the radar data, and transmit the radar spectrum to the control module 102. In such examples, the radar spectrum generated by the control module 102 or received by the control module 102 may be a radar tensor formed of range values, angle values, and Doppler values, as is conventional.

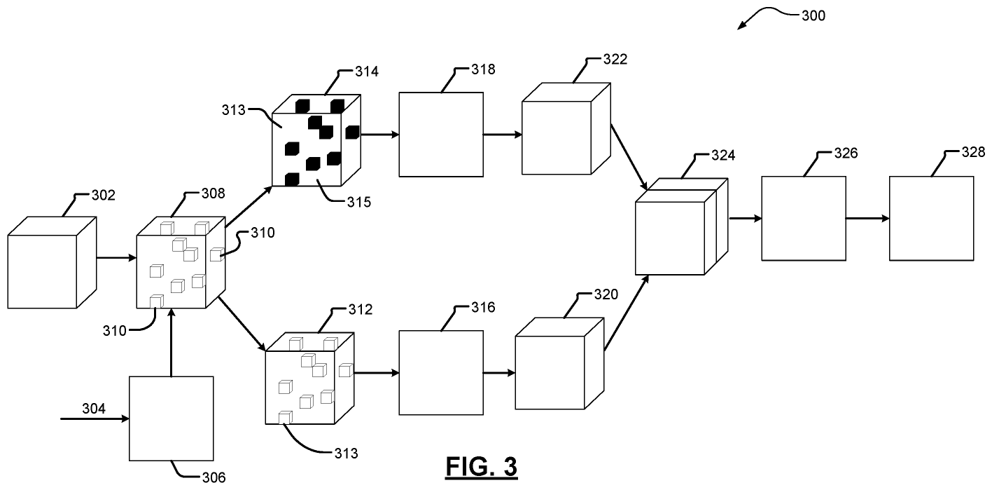

For example, FIG. 3 depicts an example control process 300 employable by the vehicle system 100 of FIG. 1 for enhancing object detection. In the example of FIG. 3, the process 300 may be implemented with one or more modules in the control module 102 as further explained below. Although the example control process 300 is described in relation to the vehicle system 100 of FIG. 1 including the control module 102, the control process 300 may be employable by another suitable system. In the process 300, a three-dimensional radar tensor 302 is generated or received. In this example, the three-dimensional radar tensor 302 includes angle values (e.g., in the y direction), range values (e.g., in the x direction) and Doppler values (e.g., in the z direction) for both static and dynamic objects.

Then, the control module 102 of FIG. 1 partitions the radar spectrum into static reflections and dynamic reflections separate from the static reflections. In such examples, the control module 102 may first identify the reflection points for the static and dynamic reflections. In doing so, the control module 102 avoids processing noise that may interfere with the analysis of the static and dynamic reflections. This may be accomplished by comparing detection points to a threshold value (e.g., a value above a noise level to remove noise).

In various embodiments, the control module 102 can partition the radar spectrum based on a velocity of the vehicle (e.g., the vehicle 200 of FIG. 2). In such examples, the velocity of the vehicle may be received as an input (e.g., a velocity input 304 of FIG. 3) or otherwise obtained in a variety of manners. For instance, the control module 102 may receive one or more signals from the velocity sensor 110 indicative of the velocity of the vehicle. In such examples, the velocity sensor 110 may be an inertial measurement unit (IMU) or another suitable sensor for generally detecting the velocity of the vehicle.

In other examples, the control module 102 may estimate the velocity of the vehicle if, for example, the velocity sensor 110 is unavailable. In such examples, the velocity may be estimated based on data from the radar tensor. For example, the Doppler values may be used based on a proximity to the vehicle's velocity. In some examples, the static reflection points of the radar tensor may be detected by clustering Doppler values of detection points. In such examples, the largest cluster may be static reflection points. For example, the vehicle's velocity may be estimated according to a detection point index (e.g., a cluster) of static reflections, and the estimated velocity may be broken into vectors (e.g., vₓ, v_{y}) which may then be used to partition the radar spectrum into static reflections and dynamic reflections.

As one example, equations 1-3 below represent an approach to estimate the vehicle's velocity based on a cluster of Doppler values of detection points. In equations 1-3, f represents an index of Doppler values f₀, f₁, f_{N}, H represents a matrix of angle values θ₀, θ₁, θ_{N} corresponding to the Doppler values f₀, f₁, f_{N}, T represents a transpose operator on the matrix H, and v represents the estimated velocity based on the matrix H and a corresponding Doppler value.

$$f = [ {f}_{0} , {f}_{1} , … {f}_{N} ] \qquad Equation 1$$

$$H = [ \begin{matrix}\begin{matrix}cos {θ}_{0} & sin {θ}_{0}\end{matrix} \\ \begin{matrix}cos {θ}_{1} & sin {θ}_{1}\end{matrix} \\ ⋮\end{matrix} ] \qquad Equation 2$$

$$v = {( {H}^{T} H )}^{- 1} {H}^{T} f \qquad Equation 3$$

The control module 102 then can partition the radar spectrum by determining or calculating Doppler bins for the static reflections based on the velocity of the vehicle. In various embodiments, the control module 102 may include a Doppler bin calculation module 306 of FIG. 3 for such determinations. For example, the three-dimensional radar tensor 302 of FIG. 3 includes multiple cells (e.g., 100 range cells, 50 angle cells, 60 Doppler cells, etc.). In such examples, the Doppler bins represent an index of cells, such a first Doppler cell, a second Doppler cell, etc. for a particular range value and a particular angle value. The control module 102 (or the Doppler bin calculation module 306 of FIG. 3) can calculate or determine each Doppler bin for one of the range values and one of the angle values at the velocity (as provided by the velocity input 304) of the vehicle.

As one example, the Doppler bin calculation module 306 may implement equation 4 below for determining a Doppler bin. In equation 4, f represents a Doppler value, A represents a wavelength of the transmitted radar signal, vₓ, v_{y} represent vectors associated with the vehicle's velocity, and θ represents an angle value. In such examples, the angle value may be scanned for each range. For instance, the angle may be scanned from −50 degrees to 50 degrees for one range value, from −50 degrees to 50 degrees for another range value, etc. Then, the Doppler value may be obtained based on the velocity vectors.

$$f = \frac{1}{λ} ( {v}_{x} cos ( θ ) + {v}_{y} sin ( θ ) ) \qquad Equation 4$$

With continued reference to FIGS. 1 and 3, the control module 102 may separate the determined Doppler bins for the static reflections from the radar spectrum to partition the radar spectrum into static reflections and dynamic reflections. For example, in the process 300 of FIG. 3, a three-dimensional radar tensor 308 is shown as including Doppler bins 310 for the static reflections. In such examples, the control module 102 can separate the determined Doppler bins for the static reflections from other Doppler bins based on the vehicle's velocity. For instance, the control module 102 may determine a relative velocity between the vehicle and a detected object. If the relative velocity suggests that the object is not moving the control module 102 may determine that the object is static and classify corresponding Doppler bins as bins for the static reflections.

Then, once the Doppler bins for the static reflections are known, the control module 102 can separate the determined Doppler bins for the static reflections to partition the radar spectrum into static reflections and dynamic reflections, as shown in FIG. 3. For instance, the process 300 of FIG. 3 is shown as dividing the radar tensor 302 into radar tensors 312, 314 having static and dynamic Doppler bins along different static and dynamic paths. In such examples, the Doppler bins for the static reflections are identified (e.g., the bins 310 of the radar tensor 308) as explained above. Then, all of the remaining bins not identified as static reflections are determined to be dynamic bins for dynamic reflections. In FIG. 3, the radar tensor 312 (e.g., the same as the tensor 308) includes the static Doppler bins 313 and the radar tensor 314 includes dynamic Doppler bins 315. In this example, the dynamic Doppler bins 315 are the remaining bins in the radar tensor 314 not identified as the static Doppler bins (which are represented by the solid black bins).

With continued reference to FIG. 1, the control module 102 may then independently extract features from the static reflections and features from the dynamic reflections with different machine learning modules 116, 118. In such examples, the machine learning modules 116, 118 may be separate deep neural networks (e.g., convolutional neutral networks, etc.) or any other suitable machine learning modules trained on different data specific to dynamic and static characteristics of detected objects. For example, the machine learning modules 116, 118 may be trained (or retrained if necessary) based on one or more labeled data sets for known detected objects. Once detection errors of the machine learning modules 116, 118 are satisfied (e.g., above a threshold), the machine learning module 116 may be implemented by a static feature extraction module 316 of FIG. 3 to extract features from the static reflections and the machine learning module 118 may be implemented by a dynamic feature extraction module 318 of FIG. 3 to extract features from the dynamic reflections.

In various embodiments, different and/or independent filters may be employed on the static and dynamic paths if desired. Additionally, if desired, a set maximum of inputs may be taken on the Doppler domain to reduce an input dimension.

In some examples, the control module 102 of FIG. 1 may generate a static feature map based on the extracted features from the static reflections and a dynamic feature map based on the extracted features from the dynamic reflections. For example, and as shown in FIG. 3, a static feature map 320 may be generated based on the extracted features output from the static feature extraction module 316 (e.g., in the static path) and a dynamic feature map 322 may be generated based on the extracted features output from the dynamic feature extraction module 318 (e.g., in the dynamic path). In such examples, the static feature map 320 includes static feature vectors while the dynamic feature map 322 includes dynamic feature vectors. Each static feature vector is associated with a range value of the radar tensor 312, an angle value of the radar tensor 312, and a learnable feature identified by the machine learning module 116. Likewise, each dynamic feature vector is associated with a range value of the radar tensor 314, an angle value of the radar tensor 314, and a learnable feature identified by the machine learning module 118.

In various embodiments, the control module 102 merges the extracted features from the static reflections and the extracted features from the dynamic reflections. For example, a merger module 324 of FIG. 3 may receive the static feature map 320 and the dynamic feature map 322 and merge the feature maps. In such examples, the merger module 324 (e.g., a module in the control module 102) may merge the extracted features in any suitable manner. For example, the merger module 324 may concatenate the static feature map 320 and the dynamic feature map 322 to merge the extracted features from the static reflections and the extracted features from the dynamic reflections. In other examples, the merger module 324 may use another suitable technique to merge the extracted features, such as summing the extracted features, etc.

The control module 102 may then generate a new map of vectors based on the merged features. For example, the control module 102 may include a multilayer perceptron module 326 of FIG. 3 that receives the merged feature maps 320, 322 and applies multi-layers of 1×1 convolutions to generate an output of the combined features. In such examples, the multilayer perceptron module 326 may generate new vectors each with dynamic and static vectors. In other examples, the multilayer perceptron module 326 may use a linear layer to generate an output of the combined features.

Then, the control module 102 detects static objects and dynamic objects in the vicinity of the vehicle based on the merged features from the static reflections and the dynamic reflections. For instance, the control module 102 may process the output of the combined features to detect static and dynamic objects. In various embodiments, the control module 102 may employ conventional techniques to detect the objects. For example, the control module 102 may include an object detection module 328 of FIG. 3 that receives the output of the multilayer perceptron module 326, processes data in the outputs to detect objects, and then generates and outputs a bounding box for each detected object along with parameters associated with each bounding box (e.g., a position, a shape, an orientation, a speed, etc.). In such examples, the object detection module 328 may implement an algorithm that scans the combined features from the multilayer perceptron module 326 to detect the object.

In various embodiments, the control module 102 of FIG. 1 may then generate and transmit one or more signals indicative of the detected static objects and/or dynamic objects to the vehicle control module 112. In such examples, the control module 102 may generate the signals based on the bounding box for each detected object. Once received, the vehicle control module 112 can generate a control signal 120 for controlling one or more vehicle control systems based on the detected static objects and/or dynamic objects. For example, the vehicle control module 112 may use the signals to control driver assistance systems in an autonomous vehicle, a semi-autonomous vehicle, etc. In such examples, the driver assistance systems may include, for example, assisted acceleration/deceleration, assisted steering (e.g., assisted evasive steering, etc.), adaptive cruise control, and/or any other driver assistance system that may rely on the detection of static and/or dynamic objects in the vicinity of the vehicle.

In some examples, the detected static objects and dynamic objects may be shown on a map in the vehicle. For example, the vehicle control module 112 may generate a map including the detected static and/or dynamic objects in the vicinity of the vehicle based on received signals from the control module 102. The vehicle control module 112 may then output signals indicative of the map to the display module 114 (e.g., a display in the vehicle), which can then display the map for the driver and/or other passengers in the vehicle. In other examples, the display module 114 may receive the signals indicative of the detected static objects and/or dynamic objects from the control module 102, generate the map with the detected static and/or dynamic objects in the vicinity of the vehicle based on received signals, and display the map.

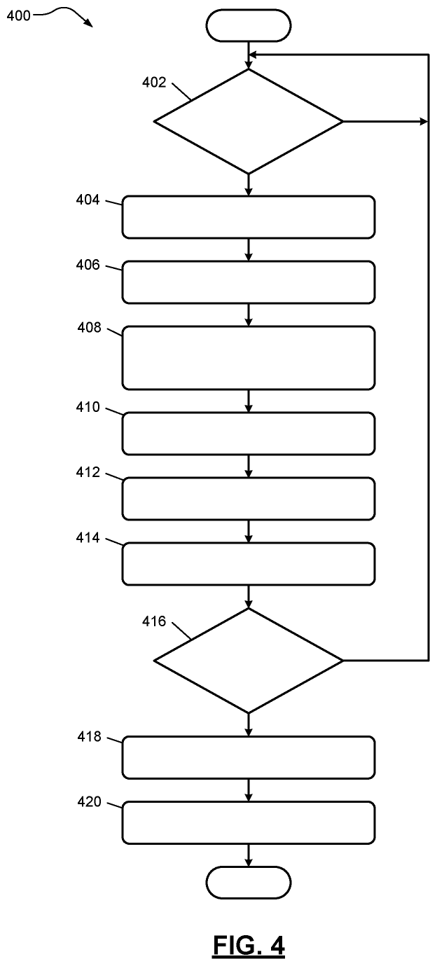

FIG. 4 illustrates another example control process 400 employable by the vehicle system 100 of FIG. 1 for enhancing object detection associated with a vehicle (e.g., the vehicle 200 of FIG. 2). Although the example control process 400 is described in relation to the vehicle system 100 of FIG. 1 including the control module 102, the control process 300 may be employable by another suitable system.

As shown, the control process 400 begins as 402 where the control module 102 determines whether any radar signals reflected by objects are detected or otherwise received. If no, control may return to 402 as shown in FIG. 4. If yes, control proceeds to 404.

At 404, the control module 102 generates or receives a radar spectrum based on the reflected signals detected by one or more radar devices (e.g., the radar devices 104, 106, 108 of FIG. 1). For example, and as explained above, the control module 102 may receive radar data, process the data, and form the radar spectrum based on the radar data. In other examples, the radar device(s) may process the radar data, form the radar spectrum based on the radar data, and transmit the radar spectrum to the control module 102, as explained above. In either case, the radar spectrum may be a radar tensor formed of range values, angle values, and Doppler values. Control then proceeds to 406.

At 406, the control module 102 determines Doppler bins for static reflections based on a velocity of the vehicle. In such examples, the velocity may be a sensed value from a suitable sensor in the vehicle or an estimated value. Additionally, the control module 102 may implement equation 4 when determining the Doppler bins for the static reflections, as explained above. Control then proceeds to 408.

At 408, the control module 102 partitions the radar spectrum into static reflection Doppler bins and dynamic reflection Doppler bins. For example, the control module 102 may separate the determined Doppler bins for the static reflections from the radar spectrum. Then, the remaining Doppler bins not identified as static reflections may be Doppler bins for the dynamic reflections. Control then proceeds to 410, 412.

At 410, 412, the control module 102 independently extract features from the static reflections and the dynamic reflections with different machine learning modules. More specifically, the control module 102 employs a trained machine learning module (e.g., a deep neural network or another suitable machine learning module) for extracting features from the static reflections at 410, and another trained machine learning module (e.g., a deep neural network or another suitable machine learning module) for extracting features from the dynamic reflections at 412. In such examples, each machine learning module may be trained on different labeled data sets for known detected static and dynamic objects, as explained above. Control then proceeds to 414.

At 414, the control module 102 merges the extracted features from the static reflections and the extracted features from the dynamic reflections. In such examples, the control module 102 may merge (e.g., concatenate, etc.) a static feature map and a dynamic feature map representing at least the extract features, as explained above. Control then proceeds to 416.

At 416, the control module 102 determines whether any static and/or dynamic objects are detected based on the merged features. For example, and as explained above, the control module 102 may process the combined features to detect static and dynamic objects. In such examples, a conventional algorithm may be used to scan the combined features to detect the object. If no object is detected, control may return to 402 as shown in FIG. 4. If, however, an object is detected, control proceeds to 418.

At 418, the control module 102 generates one or more signals indicative of the detected static and/or dynamic objects, as explained above. In such examples, the control module 102 may transmit the signal(s) to a vehicle control module (e.g., the vehicle control module 112 of FIG. 1), as explained above. Control proceeds to 420.

At 420, a vehicle action is initiated based on the signal(s). For example, the vehicle control module may generate a control signal for controlling one or more vehicle control systems based on the detected static objects and/or dynamic objects, as explained above. Additionally and/or alternatively, a display module (e.g., the display module 114 of FIG. 1) may display a map including the detected static and/or dynamic objects relative to the vehicle, as explained above. In such examples, the control module 102, the display module, and/or the vehicle control module may generate the map based on the signal(s). Control may then end as shown in FIG. 4 or return to another suitable step (e.g., 420) if desired.

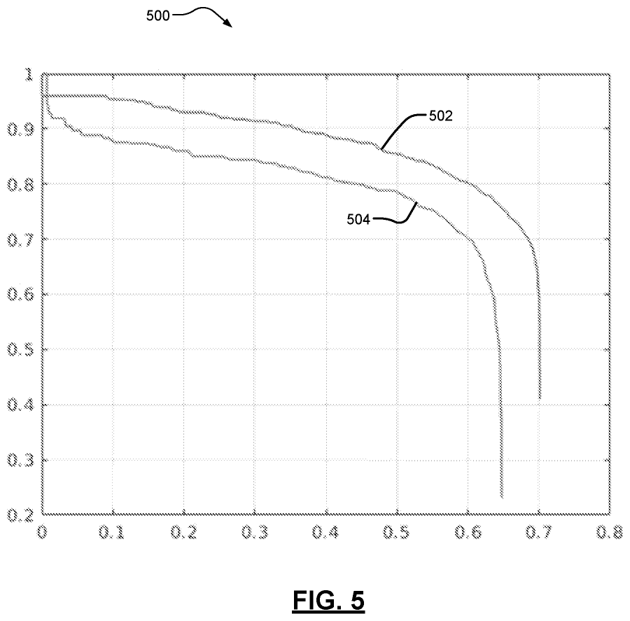

The systems and methods described herein enhance radar object detection over conventional systems and methods. For example, FIG. 5 depicts a graph 500 showing object detection improvements for a system employing object detection enhancement features as described herein over a conventional system. Specifically, in FIG. 5, the x axis represents a recall of object detection, and the y axis represents a precision of object detection. The graph 500 includes a line 502 representing object detection accuracy of a system herein that processes a radar tensor in different batches in which static and dynamic objects are separated, and a line 504 representing object detection accuracy of a conventional system that processes a radar tensor in a single batch in which static and dynamic objects are combined. In the example of FIG. 5, the area under the curve (AUC) for the line 502 is 61.85% and the AUC for the line 504 is about 52.94%, thereby indicating the system that processes the radar tensor in different batches with separated static and dynamic objects is more accurate than the conventional system.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for enhancing object detection in a vehicle, the vehicle system comprising:
at least one radar device configured to detect signals reflected by objects in a vicinity of the vehicle; and
a control module in communication with the at least one radar device, the control module configured to:
generate a radar spectrum based on the signals detected by the at least one radar device;
partition the radar spectrum into static reflections and dynamic reflections separate from the static reflections;
extract features from the static reflections with a first machine learning module;
extract features from the dynamic reflections with a second machine learning module different than the first machine learning module;
merge the extracted features from the static reflections and the extracted features from the dynamic reflections; and
detect static objects and dynamic objects in the vicinity of the vehicle based on the merged features from the static reflections and the dynamic reflections.

2. The vehicle system of claim 1, wherein the first machine learning module and the second machine learning module are separate deep neural networks.

3. The vehicle system of claim 1, wherein the control module is configured to determine Doppler bins for the static reflections based on a velocity of the vehicle.

4. The vehicle system of claim 3, wherein the control module is configured to separate the determined Doppler bins for the static reflections from the radar spectrum to partition the radar spectrum into static reflections and dynamic reflections.

5. The vehicle system of claim 3, wherein:
the radar spectrum is a radar tensor formed of range values, angle values, and Doppler values; and
each Doppler bin associates one of the range values and one of the angle values at the velocity of the vehicle.

6. The vehicle system of claim 5, wherein the control module is configured to estimate the velocity of the vehicle based on data from the radar tensor.

7. The vehicle system of claim 5, further comprising a sensor configured to detect the velocity of the vehicle, wherein the control module is configured to receive one or more signals from the sensor indicative of the velocity of the vehicle.

8. The vehicle system of claim 1, wherein the control module is configured to:
generate a static feature map based on the extracted features from the static reflections; and
generate a dynamic feature map based on the extracted features from the dynamic reflections.

9. The vehicle system of claim 8, wherein:
the static feature map includes static feature vectors, each static feature vector is associated with a learnable feature identified by the first machine learning module; and
the dynamic feature map includes dynamic feature vectors, each dynamic feature vector is associated with a learnable feature identified by the second machine learning module.

10. The vehicle system of claim 8, wherein the control module is configured to concatenate the static feature map and the dynamic feature map to merge the extracted features from the static reflections and the extracted features from the dynamic reflections.

11. The vehicle system of claim 1, further comprising a vehicle control module in communication with the control module, the vehicle control module configured to receive one or more signals from the control module indicative of the detected static objects and dynamic objects.

12. The vehicle system of claim 11, wherein the vehicle control module is configured to control at least one vehicle control system based on the one or more signals.

13. The vehicle system of claim 11, wherein the vehicle control module is configured to generate a map including the detected static objects and dynamic objects in the vicinity of the vehicle based on the one or more signals.

14. A vehicle including the vehicle system of claim 1.

15. A method system for enhancing object detection, the method comprising:
generating a radar spectrum based on signals detected by at least one radar device;
partitioning the radar spectrum into static reflections and dynamic reflections separate from the static reflections;
extracting features from the static reflections with a first machine learning module;
extracting features from the dynamic reflections with a second machine learning module different than the first machine learning module;
merging the extracted features from the static reflections and the extracted features from the dynamic reflections; and
detecting static objects and dynamic objects based on the merged features from the static reflections and the dynamic reflections.

16. The method of claim 15, wherein partitioning the radar spectrum includes determining Doppler bins for the static reflections.

17. The method of claim 16, wherein partitioning the radar spectrum includes separating the determined Doppler bins for the static reflections from the radar spectrum.

18. The method of claim 15, further comprising:
generating a static feature map based on the extracted features from the static reflections; and
generating a dynamic feature map based on the extracted features from the dynamic reflections.

19. The method of claim 18, wherein:
the static feature map includes static feature vectors, each static feature vector is associated with a learnable feature identified by the first machine learning module; and
the dynamic feature map includes dynamic feature vectors, each dynamic feature vector is associated with a learnable feature identified by the second machine learning module.

20. The method of claim 18, wherein merging the extracted features from the static reflections and the extracted features from the dynamic reflections includes concatenating the static feature map and the dynamic feature map.
